(19) United States
(12) Patent Application Publication
(10) Pub. No.: US 2021/0332952 A1
(43) Pub. Date: Oct. 28, 2021

(54) CONTINUOUS REFILL ODORANT

(71) Applicant: Welker, Inc., Sugar Land, TX (US)

(72) Inventor: Josh H. Welker, Richmond, TX (US)

(21) Appl. No.: 17/238,359

(22) Filed: Apr. 23, 2021

Related U.S. Application Data
(60) Provisional application No. 63/016,407, filed on Apr. 28, 2020.

(51) Int. Cl. F17D 3/12

(52) U.S. Cl. CPC F17D 3/12

(57) ABSTRACT

A continuous refill odorant injection system is provided that includes two tanks. A secondary tank is for short term use with an odorization system, and it can work independently or in conjunction with a primary, source tank that is able to hold more odorant than the secondary tank. This improves upon the logistics of an odorant injection system by allowing for continuous operation, less frequent odorant refill occasions, and flexibility in tank location and source location for the manufacture and transport of the larger primary tank.

### CROSS-REFERENCE TO RELATED APPLICATIONS

This Application claims priority to U.S. Provisional Patent Application Ser. No. 63/016,407, filed on Apr. 28, 2020, entitled “Continuous Refill Odorant,” currently pending, the entire disclosure of which is incorporated herein by reference.

### BACKGROUND OF THE INVENTION

Odorization systems are used to introduce an odorant to a gas so that the public can detect and report gas leaks before the concentration of leaked gas reaches a dangerous level. In the case of natural gas pipelines, to ensure natural gas is readily detectable by a person with a normal sense of smell, odorization systems have been developed to continuously and consistently impart a foul-smelling odor to gas in the pipeline.

In odorization systems, consideration must be given to how large of a tank is used to store and dispense odorant to meet the flow conditions at a particular site. Tanks that act as a source for customers can range in size, but often range between sixty (60) gallons and ten thousand (10,000) gallons in size. Such large odorant tanks are expensive and are logistically challenging because (1) the pipeline operation must be paused when the source tank is being refilled, (2) the tanks are bulky, and (3) they are difficult to move.

A solution is desired that provides an odorant system with a portable tank that may be used as a standalone odorant tank during the refilling of the large primary source tank or may be refilled during use by a larger source tank. The solution should be simple to use and can be added to a customer's existing large capacity odorant tank on an existing odorization system, whether the system is new or old and outdated, and being replaced.

### SUMMARY OF THE INVENTION

The present invention provides a continuous refill odorant injection system. The system involves adding a secondary tank that can work independently for short periods of time, or in conjunction with a larger primary source tank. This improves upon the logistics of an odorant injection system by allowing for continuous operation, less frequent odorant refill occasions, and flexibility in tank location.

In one configuration, the invention allows a continuous filling of odorant from the customer's primary source tank to the smaller secondary tank during operation. As odorant from the secondary tank is drawn upon by the pump and the pressure in the secondary tank drops, the source tank may automatically refill the secondary tank due to the relatively higher pressure in the source tank. Also, as temperature increases or decreases in either of the tanks, the liquid odorant volume may exchange and the vapor pressure within both tanks may equalize.

The invention also allows the system to operate during a refill of the source tank. The secondary tank can be isolated by closing off an isolation valve between the tanks. In this configuration, the pump may continue to draw odorant from the secondary tank as the source tank is refilled. This may reduce reliance on operation of the large tank, which can be difficult to run. The isolation valve may then be reopened to allow liquid odorant to flow from the primary tank to the secondary tank after the primary tank's refill is complete, if desired.

Because the system directly uses the source tank less frequently, and the source tank does not need to be moved as frequently, the invention allows for more odorant storage in the source tank. As such, the source tank needs to be refilled less frequently. The source tank can be sized much larger to reduce refill operation frequency and built locally. This can decrease shipping costs and make shipping of the odorant system easier.

Another benefit of the secondary tank is that it does not need a vent, flare, or vapor recovery, which is normally required for source tanks. This helps reduce operation and maintenance times.

Yet another benefit is that the issue of a system needing to be mated with a large sub-contracted tank can be eliminated. Rather, the secondary tank can be configured to allow a number of third-party large tanks to work with various odorant injection systems.

In one configuration, a complete operational system is built and supplied by a manufacturer. The locally sourced, primary storage tank is simply attached to that system but does not need to be attached to the system upon shipment. It can be integrated to the system on site.

### BRIEF DESCRIPTION OF THE DRAWINGS

FIG. 1 is a schematic of a secondary tank operating within an odorization system constructed according to the teachings of the present invention.

FIG. 2 is a schematic illustrating a full primary tank and the secondary tank of FIG. 1 prior to an initial fill.

FIG. 3 is a schematic illustrating the primary tank and the secondary tank of FIG. 2 following an initial fill.

FIG. 4 is a schematic illustrating the primary tank and the secondary tank of FIGS. 2 and 3 while a pump is in operation, the primary tank maintaining the secondary tank liquid level.

FIG. 5 is a schematic illustrating the primary tank and the secondary tank of FIGS. 2-4 while the primary tank is being refilled, and when a block valve between the primary tank and the secondary tank is closed.

FIG. 6 is a schematic illustrating the primary tank and the secondary tank of FIGS. 2-5 after the primary tank has been refilled, and when a block valve between the primary tank and the secondary tank is open, and there is a dip tube on a fill port of the secondary tank.

FIG. 7 is a schematic illustrating the primary tank and the secondary tank of FIGS. 2-6 when the primary tank has been refilled, and when a block valve between the primary tank and the secondary tank is open, and there is not a dip tube on a fill port of the secondary tank.

FIG. 8 is a schematic illustrating the primary tank and the secondary tank of FIGS. 2-7 when the primary tank has been refilled, and when a block valve between the primary tank and the secondary tank is open, and there is a dip tube on a fill port of the secondary tank.

### DETAILED DESCRIPTION OF THE INVENTION

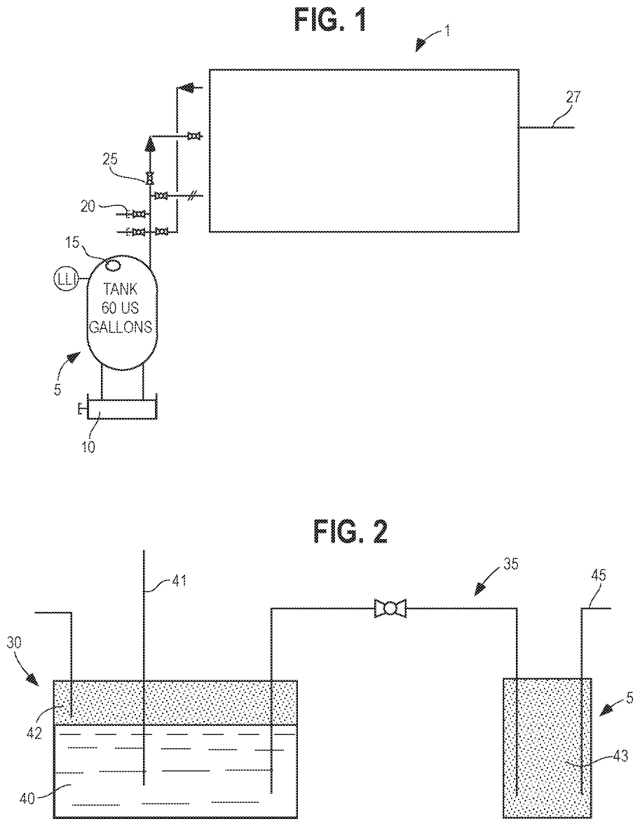

As provided in FIG. 1, an odorization injection system 1 is illustrated that may be used to introduce an odorant into a pipeline such that natural gas contained within the pipeline is odorous. Odorant introduced into the pipeline is preferably foul-smelling such that when gas leaks, a person can smell the leaking gas and prevent any further leakage and subsequent disasters.

As illustrated in FIG. 1, the odorization injection system 1 is supplied with odorant via a secondary tank member 5. The tank member 5 in the odorization injection system 1 is a sixty (60) gallon tank, though other tank sizes are foreseeable. More particularly, as will be described below, the tank member 5 may be characterized as a secondary tank. Because the tank member 5 is relatively small, it may be used in the manner illustrated in FIG. 1. Namely, the tank member 5 may be used independently from a source tank member such as those known and understood in the art. Such source tank members are described below and illustrated in the drawings that follow FIG. 1.

The injection system 1, including the tank member 5, preferably sits on a skid member 10. The tank member 5 may typically be made from carbon steel or stainless steel and is preferably mounted on the same skid member 10 as the rest of the odorization injection system 1. The tank member 5 may be equipped with a fill port 15 through which odorant may be introduced to the secondary tank member 5 via a source tank member using the process described below. Tube or pipe (not illustrated) may be provided from the fill port 15 to the source tank with a valve installed there between. As will be described below, that valve may isolate the tank member 5 from the source tank member for periods of maintenance and during refilling of the source tank. A vent port 20 may also be provided that may allow excess pressure to vent when the tank member 5 is either being filled or supplying odorant to the pipeline. As set forth below, a down comer such as a dip tube may be provided on a draw-off valve 25 associated with the odorization injection system 1 to allow for smooth odorant discharge and a full draw-off. The dip tube (or down comer) is optional and may prevent odorant from being drawn from the bottom of the source tank member since odorant found at the bottom of the source tank member may introduce debris to the tank member 5. Odorant may ultimately be delivered to a pipeline by a tube or pipe 27.

Turning to FIG. 2, the tank member 5 is illustrated as in communication with a source tank member 30 (also referred to as a primary tank member) via a tube or pipe 35. As illustrated in FIG. 2, the source tank member 30 includes a volume of liquid odorant 40 filled via a fill port 41. The liquid odorant 40 may be introduced into the secondary tank member 5 via the pipe 35 using a head pressure generated by a gas 42. In this configuration, the liquid odorant 40 is ready to be transported into the tank member 5 because the pressure of the gas 42 is greater than the pressure of a gas 43 in the secondary tank 5. Such a process may be initiated manually or automatically by pressure sensors that are present in the tank members 5 and/or 30. In such an automatic embodiment, the sensors may recognize a pressure difference between the tank members 5, 30, and they may instruct the system to begin filling the tank member 5. The liquid odorant 40 may subsequently be delivered to the injection system 1 via a tube or pipe 45.

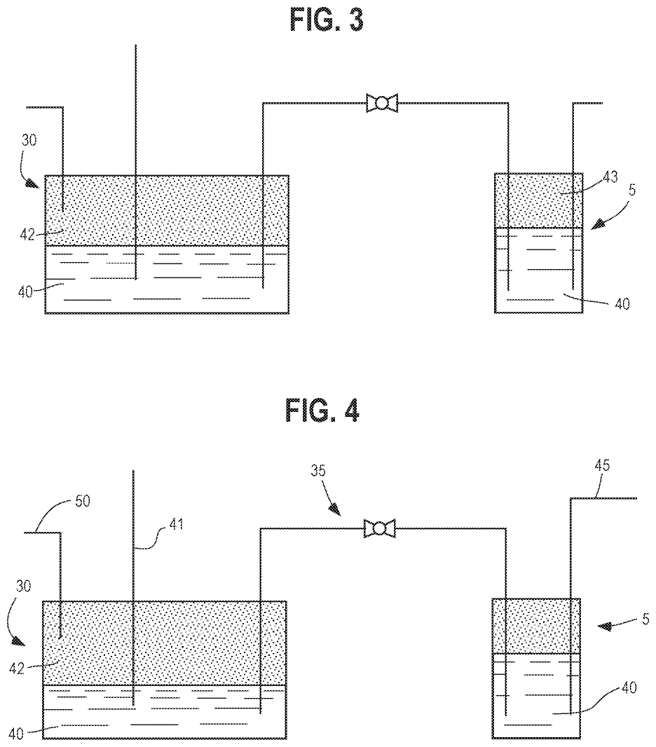

In the embodiment illustrated in FIG. 3, both tank members 5, 30 are pressurized. The secondary tank member 5 has been filled with a volume of liquid odorant 40 that compresses the gas 43 such that the pressure of the gases 42, 43 within the tank members 5, 30 are equal. In this configuration, the gas 42 may primarily be composed of vapor generated by the liquid odorant 40 stored within the tank member 30. After this “initial fill” of the tank member 5, the tank members 5, 30, have equal pressures, and the source tank member 30 may stop filling the tank member 5.

FIG. 4 illustrates the state of the tank members 5, 30, as a downstream pump (not illustrated) of the injection system 1 draws liquid odorant 40 from the tank member 5 via the pipe 45. As liquid odorant is drawn from the tank member 5 via the pipe 45, the liquid odorant 40 within the tank member 5 is replaced by liquid odorant 40 from the tank member 30 (via the pipe 35). In this embodiment, the tank member 30 may continuously provide the tank member 5 with the liquid odorant 40, even when the injection system 1 is in use, so as to maintain the liquid level of the tank member 5. To help provide a continuous supply of liquid odorant 40 to the tank member 5, additional quantities of gas, such as a blanket gas, may be supplied to the source tank member 30 via a pipe 50. The blanket gas provided via the pipe 50 may increase the quantity of gas 42 in the source tank member 30 to preferably keep the tank members 5, 30 at pressure equilibrium. Thus, by continuously introducing blanket gas to the source tank member 30, the secondary tank member 5 may maintain a volume of liquid odorant 40 that is desired by a user.

In one embodiment, the desired volume of liquid odorant 40 within the tank member 5 may be forty (40) gallons. However, in alternative embodiments, the volume of liquid odorant 40 within the tank member 5 may vary greatly, depending on a particular user's preference. In any case, pressure between the tank members 5, 30 preferably remain at equilibrium relative to one another while liquid odorant 40 is drawn from the secondary tank member 5, via the pipe 45 to the injection system (not illustrated).

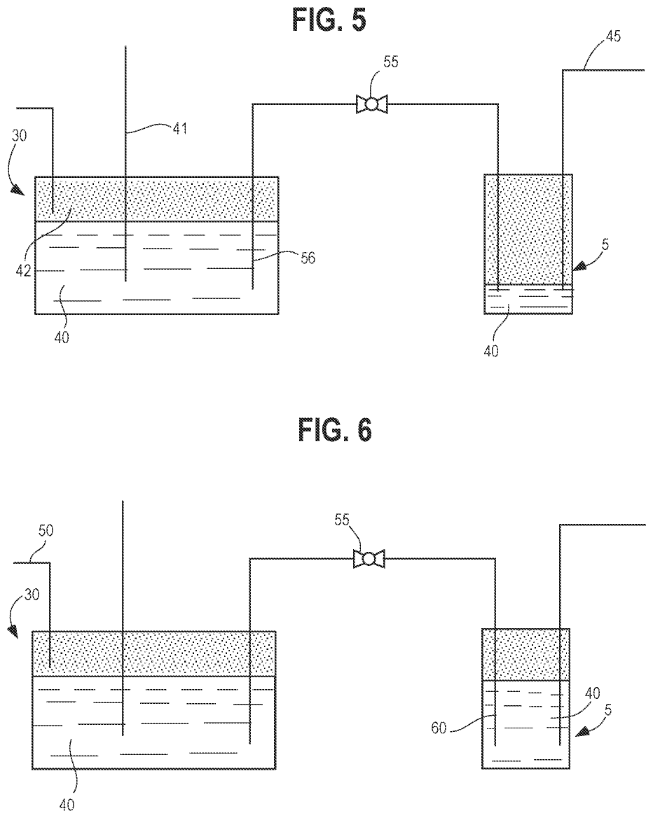

At some point, the liquid odorant 40 in the primary tank member 30 may become depleted or close to being depleted, and thus in need of refill. In FIG. 5, a valve 55 is provided between the tank members 5, 30. In the embodiment illustrated in FIG. 5, the valve 55 is shut while the primary tank member 30 is being refilled via the fill port 41 (which may be equipped with a down comer or dip tube similar to the dip tube 56). The valve 55 may be shut to prevent pressure from the tank member 5 from equalizing back to the tank member 30 since the gas 42 is released from the tank member 30 during refill. In this embodiment, the tank member 5 may be acting independently, as illustrated in FIG. 1. While the tank member 30 is being refilled, the pump member may continue to draw liquid odorant 40 from the tank member 5 via the pipe 45 until vapor pressure within the tank member 5 drops too low to be able to continue to feed the pump member. As a non-limiting example, one (1) gallon of liquid can feed approximately nine (9) million standard cubic feet (“MMSCF”) of gas to a downstream pump member. After the refill of the primary tank member 30 is complete, the required blanket pressure on the tank member 30 may be restored by increasing the quantity of the gas 42 within the tank member 30. Then, the valve 55 may be reopened and the system may return to the equilibrium state described above.

Turning now to FIG. 6, an embodiment where the primary tank member 30 has been refilled with liquid odorant 40 is provided. In this embodiment, the valve 55 is open, and a dip tube 60 is provided within the fill port 15 (illustrated in FIG. 1) of the secondary tank member 5. In this embodiment, if the required blanket pressure has not been restored to the primary tank member 30, the tank member 5 may empty some of its liquid odorant 40 into the primary tank member 30 when pressure in the primary tank member 30 is reduced to a point where its pressure is lower than the tank member 5.

At this time, the primary tank member 30 has been filled and the tank member 5 may remain empty while there is no change in the pressure of tank member 5. This may be because the pump is not in operation. When the primary tank member 30 is sufficiently full, blanket gas which has been applied to the primary tank member 30 via the pipe 50 may cause liquid odorant 40 to be reintroduced into the tank member 5, and the pressure equilibrium may be restored between the tank members 5, 30.

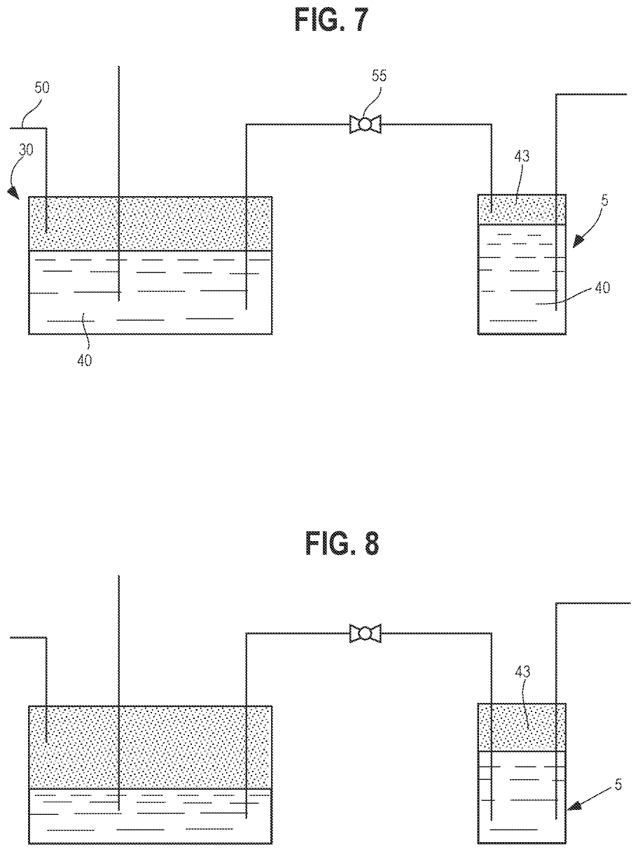

In yet another alternative embodiment illustrated in FIG. 7, the valve 55 is similarly open, but there is not a dip tube associated with the tank member 5. In this embodiment, the injection system 1 is paused and thus the pump does not draw liquid odorant 40 from the secondary tank member 5. As a result, the volume of liquid odorant 40 in the secondary tank member 5 does not change. Pressure on the secondary tank member 5 drops to zero. Subsequently, when the primary tank member 30 fills, and because of the absence of a dip tube, it does not affect pressure in the tank member 5, and the secondary tank member 5 remains full. At this time, blanket pressure may be provided via the tube 50 on the primary tank member 30, and the tank member 5 may be provided with additional liquid odorant 40. Thus, it is desirable to have a dip tube for the fill port 15 of the secondary tank member 5. This may help to maintain a constant mass of the gas 43 within the tank member 5, such as illustrated in FIG. 8.

It should be noted that the state of the tank members 5, 30 may vary depending on temperature. Such variability in temperature may depend on the location of the primary tank member 30 (e.g., indoors or outdoors), the materials the tank members 5, 30 are composed of, properties of the liquid odorant 40, and other foreseeable variables. As is well-known and understood in the art, in order to maintain certain pressures between the tank members 5, 30, distributions of the liquid odorant 40 within the tank members 5, 30 may vary in various embodiments.

As is evident from the foregoing description, certain aspects of the present invention is not limited by the particular details of the examples illustrated herein, and it is therefore contemplated that other modifications, applications, variations, or equivalents thereof, will occur to those skilled in the art. Many such changes, modifications, variations and other uses and applications of the present constructions will, however, become apparent to those skilled in the art after considering the specification and the accompanying drawings. All such changes, modifications, variations and other uses in applications which do not depart from the spirit and scope of the present inventions are deemed to be covered by the inventions which are limited only by the claims which follow.

1. An odorant injection system for introducing an odorant into a pipeline, the system including:
a first tank member that stores a quantity of odorant; and
a second tank member from which a pump of the odorant injection system can draw odorant;
wherein the second tank member is smaller than the first tank member and is configured to be refilled from the first tank member.

2. The odorant injection system of claim 1, wherein the second tank member is configured to independently operate the odorant injection system.

3. The odorant injection system of claim 1, wherein the first tank member can be configured to fill the second tank member manually or automatically within operational parameters of an odorization system.

4. The odorant injection system of claim 1, wherein each of the first tank member and the secondary tank member includes a down comer.

5. The odorant injection system of claim 1, wherein the second tank member can be isolated from the first tank member without interruption to the odorant injection system while the first tank member is being refilled or serviced.

6. The odorant injection system of claim 1, the system further including a valve between the first tank member and the second tank member.

7. The odorant injection system of claim 6, wherein the first tank member may be filled with odorant independently from the second tank member when the valve is closed.

8. The odorant injection system of claim 6, wherein odorant may be supplied to the second tank member from the first tank member when the valve is open.

9. The odorant injection system of claim 1, wherein a gas supplied to the first tank member drives the odorant from the first tank member to the second tank member.

10. The odorant injection system of claim 1, wherein the first tank member and the second tank member may exchange a volume of odorant to maintain pressure equalization as the temperature of the first tank member and the second tank member change.

11. An odorant injection system for introducing an odorant into a pipeline, the system comprising:
a source tank;
a secondary tank in fluid communication with the source tank;
a volume of odorant stored within at least one of the source tank and the secondary tank; and
a pump in fluid communication with the secondary tank for drawing odorant from the secondary tank.

12. The odorant injection system of claim 11, wherein the source tank has a first volume, the secondary tank has a second volume, and the first volume is greater than the second volume.

13. The odorant injection system of claim 11, wherein the secondary tank is configured to independently operate the odorant injection system.

14. The odorant injection system of claim 11, wherein the source tank is configured to fill the secondary tank manually or automatically within operational parameters defined by a user.

15. The odorant injection system of claim 11, wherein the source tank delivers odorant to the secondary tank as the pump draws odorant from the secondary tank.

16. The odorant injection system of claim 11, wherein at least one of the source tank and the secondary tank include a down comer.

17. The odorant injection system of claim 11, further including a pipe in fluid communication with the source tank and wherein the pipe supplies a gas to the source tank.

18. The odorant injection system of claim 17, wherein the gas supplied via the pipe to the source tank increases the pressure within the source tank.

19. The odorant injection system of claim 11, the odorant injection system further including a valve located between the source tank and the secondary tank.

20. The odorant injection system of claim 11, wherein the source tank may be refilled independently of the secondary tank as the pump draws odorant from the secondary tank.
